(19) United States
(12) Patent Application Publication
(10) Pub. No.: US 2009/0272188 A1
(43) Pub. Date: Nov. 5, 2009

(54) Binary Liquid Analyzer For Storage Tank

(75) Inventors: Paul Byrne, McKinney, TX (US); Phillip P. Harris, Perryton, TX (US)

Correspondence Address: TOMLINSON & O'CONNELL, P.C., TWO LEADERSHIP SQUARE, 211 NORTH ROBINSON, SUITE 450, OKLAHOMA CITY, OK, 73102, US

(73) Assignee: Well Tech Instruments, LLC, Perryton, TX (US)

(21) Appl. No.: 12/434,395

(22) Filed: May 1, 2009

Related U.S. Application Data
(60) Provisional application No. 61/049,623, filed on May 1, 2008.

(51) Int. Cl. G01F 23/38; G01L 9/04

(52) U.S. Cl. 73/309; 73/726

(57) ABSTRACT

A fluid analysis system for use with a storage tank containing a plurality of fluids. The storage tank includes a drain outlet near the bottom of the tank and an opening at the top of the tank. The fluid analysis system includes a tube supported by the tank, at least one pressure sensor at the bottom of the tank, a fluid level sensor, and a processor. The tube extends from the opening of the tank to a position the bottom of the tank and supports the pressure sensor and the fluid level sensor. The fluid level sensor includes a reed switch assembly supported inside the tube and a magnetic float buoyantly supported on the exterior of the tube. The processor receives the pressure of the fluid detected by the pressure sensor and the fluid level detected by the fluid level sensor. The processor can determine a height of each of the fluids in the storage tank using the detected fluid pressure and the detected fluid level. A signal is transmitted when a ratio between the fluid heights remains substantially unchanged from a previously determined ratio, as fluid is drained from the tank.

### CROSS REFERENCE TO RELATED APPLICATIONS

This application claims priority of U.S. Provisional Patent Application Ser. No. 61/049,623 filed May 1, 2008, the contents of which are incorporated herein by reference.

### FIELD OF THE INVENTION

The present invention relates generally to storage tanks and more particularly to analysis of fluids in storage tanks.

### SUMMARY OF THE INVENTION

The present invention is directed to a fluid storage tank system. The system comprises a storage tank adapted to hold a plurality of fluids, a tube supported by the tank, a pressure sensor, a fluid level sensor, and a processor. The storage tank comprises a drain outlet proximate a bottom of the tank and an opening proximate a top of the tank. The tube extends from the opening of the tank to a position proximate the bottom of the tank. The pressure sensor is supported on a bottom end of the tube and is adapted to detect a fluid pressure in the tank. The fluid level sensor is supported by the tube and is adapted to detect a fluid level in the tank. The fluid level sensor comprises a magnetic float movably supported on an exterior of the tube and a reed switch assembly supported inside the tube. The float is adapted to be buoyant in the fluids and the reed switch assembly is adapted to detect a position of the magnetic float along the length of the tube. The processor is electrically connected to the pressure sensor and the fluid level sensor, and is adapted to determine a height of a first fluid in the storage tank and a height of a second fluid in the storage tank using the detected fluid pressure and the detected fluid level. The processor is further adapted to transmit a signal when a ratio between the fluid heights remains substantially unchanged from a previously determined ratio.

In another embodiment the present invention comprises a fluid storage tank system having a storage tank and a fluid analysis system. The storage tank is adapted to hold a plurality of fluids. The fluid analysis system comprises a pressure sensor, a fluid level sensor and a processor. The pressure sensor is adapted to detect a fluid pressure proximate a bottom of the tank. The fluid level sensor is adapted to detect a fluid level in the tank. The processor is adapted to determine a height of a first fluid in the storage tank and a height of a second fluid in the storage tank using the detected fluid pressure and the detected fluid level.

In yet another embodiment the present invention is directed to a method for analyzing fluids in a storage tank, each fluid having a known specific gravity. The method comprises the steps of measuring a pressure of the fluids proximate a bottom point of the storage tank, measuring a total height of the fluids in the storage tank, and determining a height of a first fluid and a height of a second fluid using the measured pressure, the measured height, and the known specific gravities of the fluids.

### BRIEF DESCRIPTION OF THE DRAWINGS

FIG. 1 is a front elevation view of a storage tank supporting a fluid analysis system built in accordance with the present invention.

FIG. 2 is a partial sectional view of the tube used in the system shown in FIG. 1.

FIG. 3 is a flow diagram of a version of software for the processor of the fluids analysis system of the present invention.

### DETAILED DESCRIPTION

With reference now to the drawings and to FIG. 1 in particular, the present invention comprises a storage tank 10 and a fluids analysis system 12. The storage tank 10 is preferably adapted to store fluids such as oil. One skilled in the art will appreciate that although the tank 10 may be used to store a fluid such oil, other fluids such as water may inadvertently be added to the tank. The fluid analysis system 12 of the present invention provides for an assessment of the relative amounts of fluids of different densities that are in the tank 10. The fluid analysis system 12 is operative to assess the relative heights of fluids in the tank 10 as a function of the total pressure or weight and total height of the fluids as a function of the densities of the fluids in the tank. As the depth of fluid increases in the storage tank 10, the pressure at a bottom of the tank increases. This effect is known as the hydrostatic pressure or the pressure head of the fluids. Factors involved in this measurement include the height of the fluid (fluid depth), the density of the fluid, and the earth's gravity. As will be demonstrated below, the value of the earth's gravity is assumed to be a constant will factor out of calculations used.

The tank 10 is generally cylindrical in nature (but can be of any shape), and will have a top portion 14 and a bottom portion 16. The tank 10 will comprise a drainage valve 18, proximate the bottom 16 of the tank, that will be operable between open and closed positions to allow for fluids in the tank to be drained from the tank. At least one opening or port 20 is preferably disposed near the top 14 of the tank. Preferably, the port 20 will be centrally positioned in the top 14 of the tank. Other openings or ports (such as opening 21) may be present for purposes of having sensors or other like devices installed on the tank 10.

The fluid analysis system 12 comprises a pressure sensor 22, a fluid level sensor 24, and a processor 26. The pressure sensor 22 is used to determine the pressure exerted by the weight of the fluids proximate the bottom 16 of the tank 10. The fluid level sensor 24 will measure the level, or height, of the fluid in the tank 10. The processor 26, operatively connected to the pressure sensor 22 and the fluid level sensor 24, will determine the relative amounts of fluids in the tank 10 in a manner described below. Preferably, the fluid analysis system will further comprise a user interface station 27 for an operator. The interface station 27 would preferably comprise a graphical LCD display and keyboard or other means for the operator to input information.

In the preferred embodiment, the system 12 further comprises a tube 28 supported within the tank 10. The tube 28 is preferably secured to the port 20 at the top 14 of the tank 10 with a tank fitting 30 and extends to the bottom 16 of the tank. The tube 28 has an inside that provides a conduit isolated from the fluids for electronics connections or housing other sensors.

The pressure sensor 22 is preferably secured to a bottom end of the tube 28. In the preferred embodiment, the pressure sensor 22 comprises a pressure transducer using a strain gauge Wheatstone Bridge. The pressure sensor 22 is adapted to measure the hydrostatic pressure or pressure head of the fluids in the tank 10. The pressure sensor 22 may be electronically connected to the processor 26 with wires passing through the tube 28. Alternative embodiments for the pressure sensor 22 are anticipated, including a pressure manometer, a load cell, a pressure bubbler, spring bellows, or a means for weighing the total weight of the fluids in the tank 10.

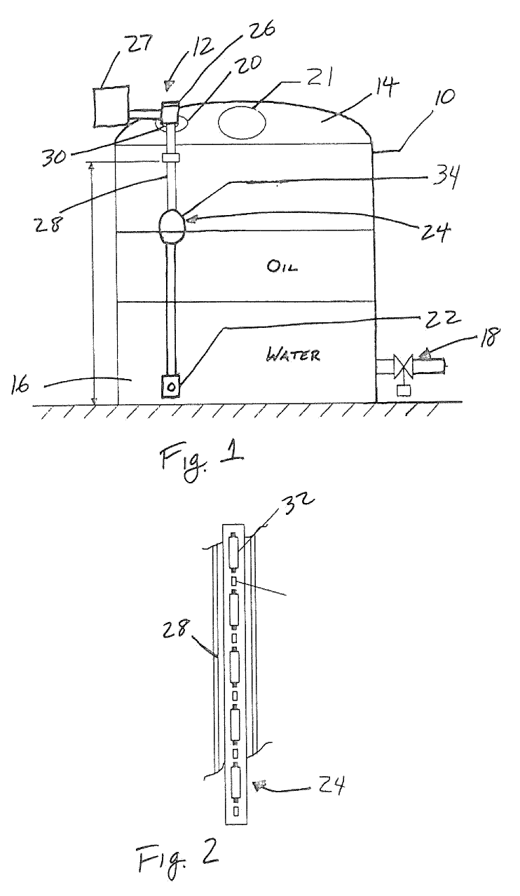

The fluid level sensor 24 of the present invention comprises a series of magnetically responsive reed switches 32 (shown in FIG. 2) and a ring magnet embedded in a float 34. The reed switches 32 are supported on the inside of the tube 28 and extends a full length of the tube. The magnetic float 34 is buoyantly supported on an exterior of the tube 28. The float 34 may be a rubber ball float with a magnetic inside, provided the float is less dense than the fluids in the tank 10. Because the float 34 is buoyant in the fluids of the tank 10, sensors (shown in FIG. 2) in the reed switches 32 will be triggered as the float moves up and down the tube 28. The reed switches 32 may be electronically connected to the processor 26 with wires passing through the tube 28. Alternative embodiments for the fluid level sensor 24 are anticipated, including float systems using cables or potentiometers, ultrasonic ranging systems, and laser ranging systems.

The processor 26 is adapted to receive signals from the pressure sensor 22 indicative of the pressure head of the fluids in the tank 10 and the fluid level sensor 24 indicative of the height of the fluid in the tank. The processor 26 is programmed to use the equation that relates Pressure, Fluid Depth, Fluid Density and Gravity is:

P=ρgH

Where P=Total Pressure Head, ρ=Density of the fluid, g=Earth Gravity Constant, and H=Total Fluid Height. In a storage tank 10 where different fluids of differing densities are present, the equation would be:

P=ρ₁gh₁+ρ₂gh₂ . . . +ρₙghₙ

Thus, the sum of the products of the different individual fluid heights and densities would produce the total pressure P.

To simplify the equations, the Weight Density will be used instead of the absolute density and gravity constant, thus:

P=βH

Where: β=ρg=(Fluid Density)×(Gravity Constant)=Weight Density.

These equations can then be used to determine the ratio of relative amounts of fluids in the tank 10 where the tank includes more than one fluid. In particular, the present invention is useful for identifying the amounts of oil and water in the tank 10. The processor 26 is adapted to use the relational equations for two liquids in the tank 10 as follows:
Pressure due to Oil: pₒ=ρₒghₒ=βₒhₒ
Pressure due to Water: p_{w}=ρ_{w}gh_{w}=β_{w}h_{w}
Total Pressure: P=ρgH=βₒhₒ+β_{w}h_{w}
   And the equations then become:

hₒ=(P−β_{w}H)/(βₒ−β_{w})

h_{w}=(P−βₒH)/(β_{w}−βₒ)

Here, it can be seen that the Oil Height hₒ and Water Height h_{w} can be calculated if the Total Pressure P and Total Height H are both known.

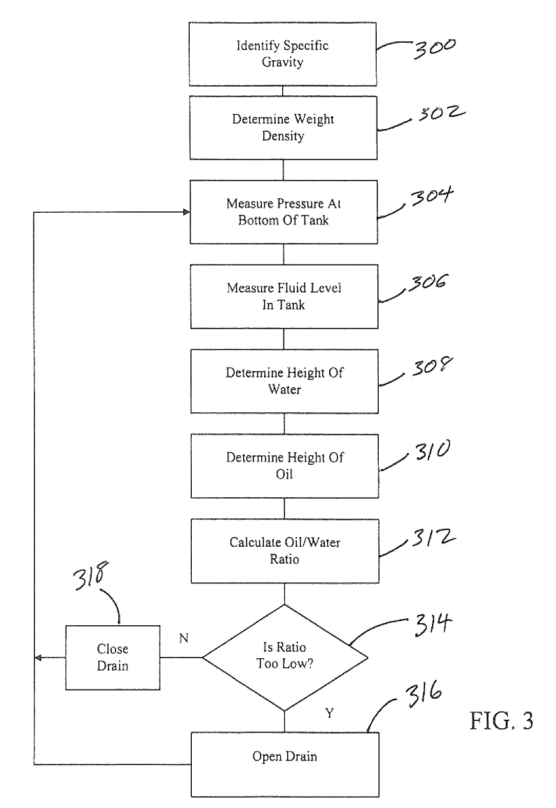

With reference now to FIG. 3, there is shown therein a flowchart showing the process for using the present invention to determine the ratio of water to oil in the storage tank 10. In the tank 10 there exists a level of oil and a level of water which are both unknown. First at step 300, the operator is required to enter the specific gravity of the oil, the specific gravity of the water, and the pressure range for the pressure sensor (0-10 psi for this discussion). Next at 302, the processor then determines the Weight Density by multiplying each Specific Gravity by the weight density of pure water (0.0361). The Weight Densities are then used in the calculations.

The pressure sensor 22 then measures the pressure of the Hydrostatic Head at 304 and communicates the pressure to the processor 26. The processor 26 may be adapted to account for the Full Scale Pressure for the Transducer (in this case 10.00 psi) and a resolution of an Analog to Digital Converter (A/D), preferably 24 bits. Lesser resolution is also possible, but more preferably the resolution should not be reduced below 12 bits.

The fluid level sensor 24 then measures the fluid level at 306 by analyzing which reed has been activated by the magnet inside the float 34 and communicates the fluid level to the processor 24. The processor 24 preferably accounts for a buoyancy characteristic of the float 34 and calculates the fluid level as it relates to the surface of the float. As it is not known at this point if the level of fluid is higher than the reed being tripped, this level is identified as a preliminary level, H. Using the preliminary fluid level H, the processor 26 calculates the height of the water h_{w} at 308 and the oil hₒ at 310. Then, at 312, the processor 26 calculates a ratio between the two using the following formulas:

hₒ=(P−β_{w}H)/(βₒ−β_{w})

h_{w}=(P−βₒH)/(β_{w}−βₒ)

Ratio=hₒ/h_{w}, so R=hₒ/h_{w}, hₒ=Rh_{w}, and h_{w}=hₒ/R.

Preferably, the following information is then displayed for the operator on the graphical LCD interface display:
Total Fluid Height H (hₒ+h_{w})
Total Oil Height hₒ
Total Water Height h_{w}

Next, the processor 26 uses the ratio calculate new oil and water levels using the formulas:

P=p_{w}+pₒ=β_{w}h_{w}+βₒRh_{w}=h_{w}(β_{w}+R)+βₒ)

h_{w}=P/(β_{w}+Rβₒ) an: hₒ=P/((β_{w}/R)+βₒ)

H=(P/(β_{w}+Rβₒ))+(P/((β_{w}/R)+βₒ))

These calculations are used until the next reed switch 32 is activated by the magnetic float 34. When this occurs, the processor 26 then knows the “exact” fluid level because of the geometry of the level sensor, and the buoyant nature of the float 34, in relationship to the physical dimensions of the tank 10. The Oil/Water Ratio will then be recalculated as further reed switch 32 sensors are activated, either UP or DOWN.

As the relative ratios of the fluids are provided to the operator, the drain valve 18 of the tank 10 can be used to allow water in the tank to be removed. Because the oil is more important than the water, it is necessary to drain the water from the tank 10, but not to drain the oil. This is accomplished by continually sensing the Oil/Water Ratio. As the water is drained from the tank 10, the Oil/Water Ratio will increase as the total level of fluid (H) lowers. The processor 26 is preferably adapted to determine when the fluid level (H) is dropping but the Oil/Water Ratio is not changing proportionally or remains substantially unchanged. At that point in time, it indicates that the interface between the oil and the water has reached the drain valve 18. The processor 26 will then transmit a signal to the operator to indicate the emulsion layer (a mixture of Oil and Water) has been reached. At this point, the drain valve 14 is closed and the water has been extracted from the tank 10. In an embodiment with automatic control of the draining of fluid, the processor 26 may be operatively connected to the drain valve 18 so that the draining of the water, or other fluid, may be done automatically. With this embodiment, the processor 26 checks the Oil:Water ratio at 314. If the ratio is below a predetermined level, indicating more water is present than is desired, the processor 26 is adapted to open the drain valve 18 at 316. If the ratio is not too low, the processor 26 can also be programmed at 318 to close the valve 18 as the ratio suggests the emulsion layer has been reached.

The fluid analysis system 12 of the present invention may also be used in an application when different amounts of water at different densities are present in the tank 10. In a situation where a single fluid is being measured, such as water only, the processor 26 can be used to calculate the level of water based on Pressure (P) and the Weight Density of the Water (β_{w}). Thus, the following calculations can be made by the processor 26:

P=β_{w}h_{w}

h_{w}=P/β_{w} and

β_{wt}H=β_{w1}h_{w1}+β_{w2}h_{w2}

### Where:

β_{wt}=Weight Density of water total (average)
β_{w1}=Weight Density of Water at level #1
β_{w2}=Weight Density of Water at level #2
h_{w1}=Level of Water #1
h_{w2}=Level of Water #2

Then, if the original pressure is p₁ and the original weight density is β_{w1}, the original height can be calculated as: h₁=p₁/βw₁. Furthermore, if we know the new weight density βw₂ and the new total pressure pₜ, we can calculate that the pressure due to increase in water height h₂ is: h₂=pₜ−p₁. Therefore: the new height is: H=p₁βw₁+(pₜ−p₁) βw₂.

This information can then be displayed on the display as a total fluid height. One skilled in the art will appreciate the present invention allows for an accurate liquid level system to be obtained from a single pressure transducer. The system can also be used for other combinations of multiple liquids where the densities of the liquids are known. Additionally, in an alternative embodiment for the fluid analysis system, the calculations could be made using a weight of the fluids, and a means for measuring the total weight could be used in place of the pressure sensor 22.

In an alternative embodiment for the fluid analysis system 12, the system may comprise a plurality of pressure transducers proximate the bottom of the tank 10. Preferably, two pressure transducers would be positioned a known distance apart in the tank 10. More preferably, the pressure transducers would be placed six inches apart. When there is fluid in the tank 10, the processor 26 will receive a pressure reading from each of the two pressure transducers. The processor 26 can then determine the weight density of the fluids using the relationship: β=(p₁−p₂)/d. Where β=Weight Density of the fluid, p₁ and p₂ are the pressures from the two pressure transducers, and d=the known distance between the two pressure transducers.

Various modifications can be made in the design and operation of the present invention without departing from the spirit thereof. Thus, while the principal preferred construction and use of the invention have been explained in what is now considered to represent its best embodiments, it should be understood that the invention may be practiced otherwise than as specifically illustrated and described, and claimed in the following claims.

What is claimed is:

1. A fluid storage tank system comprising:
a storage tank adapted to hold a plurality of fluids, the tank comprising a drain outlet proximate a bottom of the tank and an opening proximate a top of the tank;
a tube supported by the tank, the tube extending from the opening of the tank to a position proximate the bottom of the tank;
a pressure sensor supported on a bottom end of the tube, the pressure sensor adapted to detect a fluid pressure;
a fluid level sensor supported by the tube, the fluid level sensor adapted to detect a fluid level in the tank; and
a processor electrically connected to the pressure sensor and the fluid level sensor, the processor adapted to determine a height of a first fluid in the storage tank and a height of a second fluid in the storage tank using the detected fluid pressure and the detected fluid level;
wherein the fluid level sensor comprises:
a magnetic float movably supported on an exterior of the tube, the float adapted to be buoyant in the fluids; and
a reed switch assembly supported inside the tube, the reed switch assembly adapted to detect a position of the magnetic float along the length of the tube.

2. The system of claim 1 wherein the pressure sensor comprises a pressure transducer using a strain gauge.

3. The system of claim 1 wherein the processor is operatively connected to the drain valve and the processor is further adapted to open the drain valve when the ratio between the fluid heights reaches a predetermined ratio and to close the drain valve when the ratio between the fluid heights reaches a second predetermined ratio.

4. The system of claim 1 wherein the processor is further adapted to transmit a signal when a ratio between the fluid heights remains substantially unchanged from a previously determined ratio.

5. A fluid storage tank system comprising:
a storage tank adapted to hold a plurality of fluids;
a fluid analysis system comprising:
a pressure sensor adapted to detect a fluid pressure proximate a bottom of the tank;
a fluid level sensor adapted to detect a fluid level in the tank; and
a processor adapted to determine a height of a first fluid in the storage tank and a height of a second fluid in the storage tank using the detected fluid pressure and the detected fluid level.

6. The system of claim 5 wherein the fluid level sensor comprises:
a tube supported by the tank, the tube having a length and extending from a top portion of the tank to a position proximate a bottom of the tank;
a magnetic float movably supported on an exterior of the tube, the float adapted to be buoyant in the fluids; and
a reed switch assembly supported inside the tube, the reed switch assembly adapted to detect a position of the magnetic float along the length of the tube.

7. The system of claim 5 wherein the pressure sensor comprises a pressure transducer.

8. The system of claim 5 wherein the processor is further adapted to determine a ratio of fluids in the tank using the height of the first fluid and the height of the second fluid.

9. The system of claim 8 wherein the processor is further adapted to transmit a signal when the ratio is substantially unchanged from a previous ratio determination.

10. The system of claim 5 further comprising a drainage valve proximate the bottom of the tank.

11. The system of claim 10 wherein the processor is operatively connected to the drain valve and the processor is further adapted to open the drain valve when the ratio between the fluid heights reaches a predetermined ratio and to close the drain valve when the ratio between the fluid heights reaches a second predetermined ratio.

12. A method for analyzing fluids in a storage tank, each fluid having a known specific gravity, the method comprising the steps of:
measuring a pressure of the fluids proximate a bottom point of the storage tank;
measuring a total height of the fluids in the storage tank; and
determining a height of a first fluid and a height of a second fluid using the measured pressure, the measured height, and the known specific gravities of the fluids.

13. The method of claim 12 further comprising the steps of:
calculating a ratio of the height of the first fluid to the height of the second fluid;
draining a predetermined amount of fluid from the storage tank;
repeating the steps of measuring a pressure, measuring a total height, and determining a height of a first fluid and a height of a second fluid, and calculating a ratio of the fluid heights until the ratio is substantially unchanged.

14. The method of claim 12 wherein the step of measuring the pressure of the fluid comprises using a pressure transducer proximate a bottom of the storage tank.

15. The method of claim 14 wherein the step of measuring the total height comprises using a magnetic float movable supported on an exterior of a tube supported in the tank, the tube comprising a reed switch assembly supported inside the tube, the reed switch assembly adapted to detect a position of the magnetic float along a length of the tube.
